(19) United States
(12) Patent Application Publication
(10) Pub. No.: US 2006/0125918 A1
(43) Pub. Date: Jun. 15, 2006

(54) Video and flashlight camera

(75) Inventor: Michael Sutton, Lemoore, CA (US)

Correspondence Address: PATTON BOGGS LLP, 8484 WESTPARK DRIVE, SUITE 900, MCLEAN, VA, 22102, US

(73) Assignee: CamLite Corporation, Phoenix, AZ (US)

(21) Appl. No.: 11/207,994

(22) Filed: Aug. 22, 2005

Related U.S. Application Data
(63) Continuation of application No. 09/050,796, filed on Mar. 30, 1998.
Application No. 09/050,796 is a continuation of application No. 08/877,246, filed on Jun. 17, 1997, now abandoned.
Application No. 08/877,246 is a continuation of application No. 08/321,486, filed on Oct. 12, 1994, now abandoned.

(51) Int. Cl. H04N 7/18; H04N 9/47

(52) U.S. Cl. 348/148; 348/143

(57) ABSTRACT

An improved security system incorporating a video flashlight for data acquisition (image data and audio data) by a security officer. The video flashlight includes a video camera, a transmitter and a power supply, in addition to the ordinary flashlight features. The camera converts an image or a series of real-time images into electronic form that is broadcast by the transmitter. A remote unit having a receiver and data capturing equipment receives the broadcast data and converts it back into electronic form. The capturing equipment includes one or more of the following: a repeater, a recorder or a monitor. In one embodiment, the security system is used by law enforcement personnel, with the remote units located in police stations and in police cars. The monitor is positioned in the passenger compartment of the police car, with the recorder locked in the trunk.

### BACKGROUND OF THE INVENTION

The present invention relates generally to wireless remote cameras. Specifically, the present invention relates to an improved security system that uses a wireless remote camera incorporated into a standard flashlight to transmit both audio and visual signals from a scene observed by a security officer or law enforcement officer.

There are many cameras in use today that transmit video signals to remote receivers. These prior art cameras are typically one of two types. Either the cameras are large and bulky or they are small and use a physical wire connection between the camera and a receiver.

There are many instances in which it would be desirable for a person to use a small, compact wireless video camera. For the purposes of providing a description of an exemplary embodiment, the requirements of law enforcement personnel or security officers will be described below. It is understood that the applicability of the present invention is not limited to the described scenario.

Law enforcement or security officers often work independently from other members of their team or force. A compact portable video camera/recorder would facilitate acquisition and memorialization of data obtained during the routine performance of their duties. Prior art video cameras are not designed for the rigorous environmental requirements of law enforcement or security officers.

An additional difficulty is that these people often perform their duties at night, or in low light conditions. A standard issue piece of equipment is a flashlight. Because the flashlight is an important tool, even if a compact portable video camera/recorder were available, a law enforcement or security officer would not be able to use both the video camera/recorder and the flashlight. One hand must always be free, allowing the officer to use other equipment to maintain the peace and safety of the public, and of the officer and the team members.

### SUMMARY OF THE INVENTION

The present invention provides apparatus and method for simply, efficiently and economically enhancing personal safety of security officers while improving the security officers' role of acquiring and memorializing data encountered during performance of their duties.

According to one aspect of the invention, it includes a video flashlight for emitting a beam of light. The video flashlight includes a video camera having an optical axis generally along the light beam, with the video camera converting an image received along the optical axis into an electronic image. A transmitter, coupled to the video camera, broadcasts the electronic image to a remote unit as a broadcast image without a wire or physical connection to the remote unit. The remote unit includes a receiver and an image capturing mechanism. The receiver converts the broadcast image into the electronic image and the capturing mechanism can either display the electronic image on a monitor coupled to the receiver, or record the electronic image in a format for later recovery, or both.

In operation, a user preferably carries the video flashlight, day or night. Upon encountering a situation or scene for which the user desires to acquire data or memorialize data, the user activates the video camera. The video camera converts real-time images from the scene into electronic images, and the transmitter broadcasts the converted real-time images as broadcast images. The receiver converts the broadcast images back into the electronic images, and the capturing mechanism will display the real-time images on the monitor or record the images using the recorder, or both. If ambient light levels are too low, the user can operate the selectively actuable flashlight to improve the lighting levels, as needed.

In other preferred embodiments, the video flashlight integrates a microphone to convert nearby sounds into audio signals. The transmitter broadcasts the audio signals to the remote unit. A user is able to provide a narration of the situation or scene and have it captured at the remote unit. The remote unit may be installed in a passenger vehicle, with the monitor mounted to a dashboard, and the recorder locked in a trunk. The remote unit may include a repeater, allowing the electronic images and audio data to be broadcast further away from the scene, such as to other approaching vehicles or to the offices of the user.

One alternate preferred embodiment encompasses a method for providing security to an area. The method includes the steps of equipping a security officer, such as a law enforcement officer or security guard that operates as part of a security team, with a flashlight constructed to emit a light beam. A series of real-time images are broadcast from the flashlight wherein the flashlight includes an integrated, video camera and microphone coupled to a wireless transmitter. It is understood that wireless transmitter refers to transmission between a transmitter and receiver through a mechanism other than physical connection, such as by use of radio-frequency electromagnetic waves. The broadcast real-time images are received, and captured for display to a team member and/or recording for later display to a team member.

Using the alternate preferred embodiment, the security officer can point the flashlight at a scene, display and/or record real-time images of the scene to a team member, and narrate the scene to the team member. The flashlight includes a laser pointer to help the security officer identify the optical axis of the video camera to facilitate capture of desired images.

Reference to the remaining portions of the specification, including the drawing and claims, will realize other features and advantages of the present invention. Further features and advantages of the present invention, as well as the structure and operation of various embodiments of the present invention, are described in detail below with respect to accompanying drawing. In the drawing, like reference numbers indicate identical or functionally similar elements.

### BRIEF DESCRIPTION OF THE DRAWINGS

FIG. 1 is a block diagram of a preferred embodiment for security system 10;

FIG. 2 is a schematic block diagram of a preferred embodiment of the video flashlight of FIG. 1;

FIG. 3 is a front perspective view of the video flashlight shown in FIG. 1; and

FIG. 4 is a illustration of RF shielding used in the preferred embodiment for the video flashlight shown in FIG. 1.

### DESCRIPTION OF THE PREFERRED EMBODIMENT

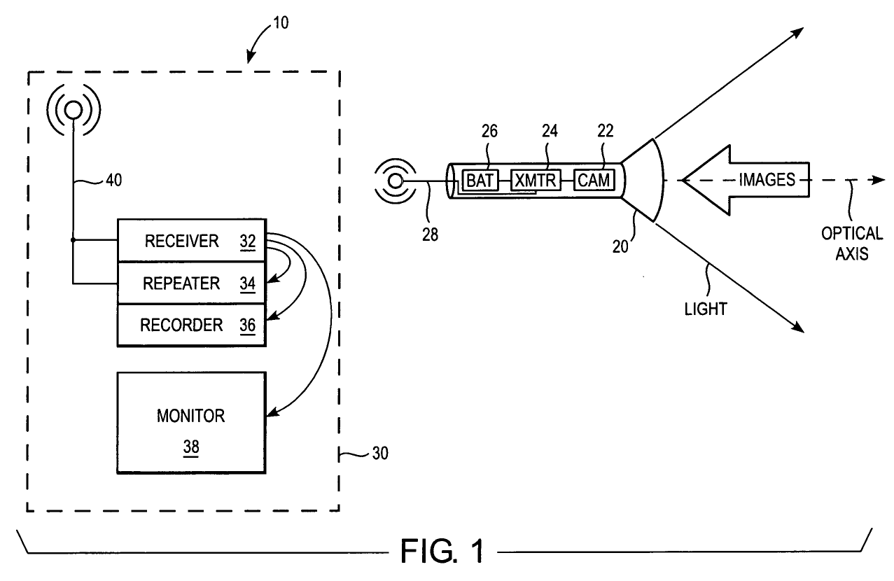

FIG. 1 is a block diagram of a preferred embodiment for security system 10. Security system 10 includes a video flashlight 20 having a camera 22, a transmitter 24, a power cell 26 and an antenna 28. Video flashlight 20 operates as a flashlight, selectively emitting a beam of light upon actuation of a switch (not shown).

Camera 22 includes an optical axis defining a field-of-view. The optical axis is generally oriented in the direction of the beam of light, allowing a user to direct the field-of-view to a particular scene just by pointing video flashlight 20 towards the scene. Camera 22 receives an image from the field-of-view and converts the image into an electronic image.

In the preferred embodiment, camera 22 includes a solid-state imaging element (not shown), such as a charge-coupled device (CCD) identified as series 60 p/n CX-060, available from various dealers through Chinon Corp. Camera 22 not only converts the image into an electronic image, it also processes the electronic image into a desired format. These formats include N.T.S.C. Video 1 volt peak-to-peak for U.S. usage and P.A.L. format for European usage.

Transmitter 24 receives the processed electronic image from camera 22. Transmitter 24 generates a series of radio frequency (RF) signals and uses processed electronic image to modulate the series of RF signals. Transmitter 24 broadcasts, through antenna 28, the modulated RF signals as well known in the art. Power cell 26, in the preferred embodiment includes, for example, one or more ‘batteries’ to power video flashlight 20 and its components, such as transmitter 24 and camera 22.

Security system 10 includes a remote unit 30 for receiving and capturing the modulated RF signals. Remote unit 30 may be located in a passenger vehicle, such as a police car, or in a security office or police station, for example. Remote unit 30, includes a receiver 32, a repeater 34, a recorder 36, a monitor 38 and an antenna 40. Receiver 32 is coupled to antenna 40 for receiving the modulated RF signals from video flashlight 20 in well-known fashion. Receiver 32 demodulates the RF signals to reproduce the electronic image broadcast from video flashlight 20. Receiver 32 sends the electronic image to repeater 34, recorder 36 and monitor 38 for capturing.

Capturing the electronic image is a term used to describe the concepts of retransmission, recording or display of the electronic image. Repeater 34 generates other RF signals and remodulates those other RF signals using the electronic image. Repeater 34 rebroadcasts those RF signals using antenna 40 in a well-known fashion. Repeater 34, in the preferred embodiment, rebroadcasts the remodulated RF signals at greater power levels than currently possible from video flashlight 20. The greater power levels provide broader dissemination of the electronic image, such as to other remote units 30, located for example, in approaching vehicles or in police stations. Typically, repeaters rebroadcast signals at a different frequency than the frequency of the signals which were broadcast to them.

Recorder 36 operates in a conventional fashion to record the electronic images from receiver 32 into a format suitable for later recovery and display. Recorder 36 is optionally actuable by receipt of a signal from receiver 32, providing that recording occurs only at such times that video flashlight 20 is transmitting. Monitor 38 receives the electronic images from receiver 32 and converts them into images presented a screen of the monitor. The conversion of electronic images into images displayed on a screen of a monitor is well-known and will not be further described herein.

In operation, a user, such as a security officer, carries video flashlight 20 as part of the standard issue set of equipment. The user will carry video flashlight 20 during the normal course of the user's activities. Video flashlight 20 will be carried in situations having high levels of ambient light as well as in those situations having lower levels. When the user desires higher levels of illumination of a particular scene, the user points video flashlight 20 at the scene and activates the flashlight's beam, just as with an ordinary flashlight. From time to time during the course of performing the user's activities, the user will come across a scene, an image of which the user desires to capture. In this instance, the user will point video flashlight 20 towards the scene and activate camera 22.

Camera 22 converts an image of the scene, or a series of real-time images of the scene, into electronic images. Transmitter 24 modulates and broadcasts the electronic image, or series of images, to any of the remote units within range.

Receiver 32 of each remote unit demodulates the RF signals to extract the electronic image, or series of images. Receiver 32 thereafter captures the electronic image, using one or more of the capturing devices that include repeater 34, recorder 36 and monitor 38. When the capturing device is monitor 38, some other user is able to view the real-time images from the scene. This is possible even though the other user is not present at the scene as long as the user maintains activation of video flashlight 20. When the capturing device is recorder 36, the scene or series of images are recorded for later viewing. When the capturing device is repeater 34, other remote units 30 are able to receive the image or the series of images from the scene, just as if they were present.

In one preferred embodiment, the user is a police officer and the police cars that convey members of the police force are equipped with remote units. Preferably, monitor 38 is mounted in the passenger compartment, with receiver 32, repeater 34 and recorder 36 locked in a trunk of the police car. The repeater rebroadcasts image information from the police officer at a crime scene to approaching officers and to the police station. The police officer is able to record suspect information onto recorder 36, or the state of a crime scene at the time the user arrived. The uses and applications of the security system are varied, providing users with improved communications, data gathering and data memorialization tools.

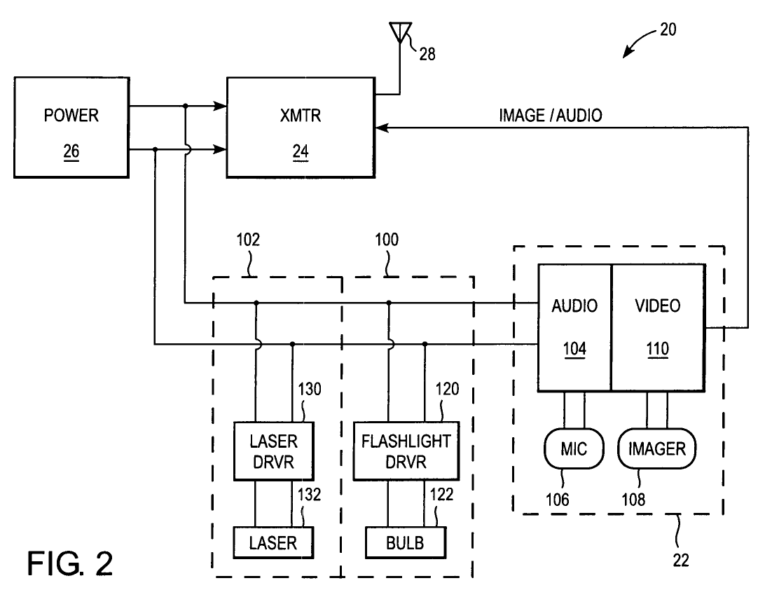

FIG. 2 is a schematic block diagram of a preferred embodiment of the video flashlight of FIG. 1. In addition to camera 22, transmitter 24, power supply 26 and antenna 28, video flashlight 20 includes a flashlight module 100, and a laser module 102, with camera 22 including an audio module 104, a microphone 106 and an imager 108.

Flashlight module 100 includes a flashlight driver circuit 120 and at least one flashlight bulb 122. Upon activation, flashlight driver circuit 120 causes bulb 122 to emit light as well-known. Laser module 102 includes a laser driver circuit 130 and a laser 132. Laser 132 is a HDA3E laser, available from Tandy Corp.

Laser 132 emits a laser beam when activated. The laser beam is oriented generally along the field-of-view of camera 22. Upon activation, laser driver circuit 130 causes laser 132 to emit a laser beam along the optical axis. The user is thereby enabled to precisely point video flashlight 20 by noting objects upon which the laser beam impinges. In other words, an object illuminated by the laser beam will appear in the field-of-view, and an image of the illuminated object will be converted and broadcast when camera 22 is activated.

Camera 22 in the preferred embodiment includes audio components to permit acquisition and memorialization of audio data from a scene. The audio components include microphone 106. for converting the audio data into audio signals. Audio module 104 receives the audio signals and processes them into a desired format. Imager 108 converts visible (or infrared) radiation from the scene, into electronic signals. In the preferred embodiment, imager 108 corresponds to the CCD described above, though it is possible to use other types of imagers for other applications.

Video module 110 receives the electronic signals and converts them into the electronic image in the proper format. Camera 22 combines the audio and image signals and sends them to transmitter 24. As described above, transmitter 24 broadcasts RF signals, modulated with the signal from camera 22. In this particular instance, the signal from camera 22 includes an audio data signal that is recoverable at remote unit 30.

Remote unit 30 will recover the audio data from the broadcast data from transmitter 24 in addition to the electronic image signal as described above. The audio data can be captured together with the associated electronic image, or separately captured. Repeater 34 is able to rebroadcast the audio data, recorder 36 can record the audio data, and monitor 38 can audiblize the audio data.

Using the embodiment shown in FIG. 2, the user is able to narrate a scene, point video flashlight 20 at the scene to convert the scene into an electronic image or series of images, and broadcast both the image and audio data to remote unit 30. Providing both image and audio data from the scene is preferable to a video only embodiment.

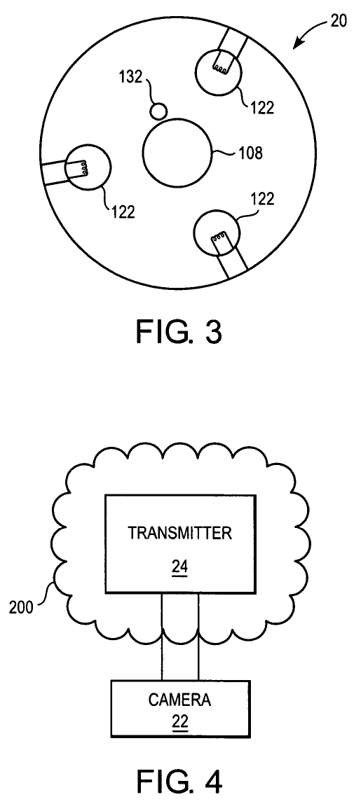

FIG. 3 is a front perspective view of video flashlight 20 shown in FIG. 1. As shown, video flashlight 20 has imager 108 mounted in a central location, with three bulbs 122 evenly distributed about the periphery of the front of video flashlight 20. The three bulbs 122 emit a beam of visible light when activated. Imager 108 has an optical axis that is generally oriented colinear to the beam of light from bulbs 122. Laser 132 is positioned to emit a laser beam along the optical axis of imager 108. Thus, the beam of light, the laser beam, and the optical axis are all generally aligned with each other.

FIG. 4 is a illustration of RF shielding used in the preferred embodiment for the video flashlight shown in FIG. 1. To provide the enhanced audio/video and transmission capabilities to a conventional flashlight, camera 22 is packed closely to transmitter 24. In order to obtain acceptable performance from video flashlight 20, RF shielding 200 surrounds a high-frequency section of transmitter 24 to reduce interference between the components of video flashlight 20.

In conclusion, the present invention provides a simple, efficient solution to a problem of providing enhanced security, enhanced data acquisition and enhanced data memorialization capabilities to security officers. While the above is a complete description of the preferred embodiments of the invention, various alternatives, modifications, and equivalents may be used. For example, the video flashlight could be used for other purposes, such as cave exploration and underwater exploration, for example. The audio/video components could be integrated into other conventional equipment, such as a miner's lantern hat. It is one feature of the present invention to provide a rugged video flashlight that could survive significant g-force shocks, such as occur if the security officer must use the flashlight in self-defense. Providing solid state construction and by using surface mount technology permits a rugged, compact design suitable for use as described above.

Other variations and modifications include use of a removable baton handle for weapons usage, use of color or infrared imagers, provision of interchangeable flashlight heads to permit different functionality or configuration of the video flashlight, modulation of the laser beam for use as a bar-code reader to read-bar-coded documents, such as driver's licenses or license plates for example, a time-delay function for the flashlight to permit imaging without direct manual operation by a lever, remote control (e.g., infrared-type) operation of all video flashlight functions to facilitate non-physical operational contact with the unit, such as for confined space surveillance or alternate point of view operation, and extendable lower body sections to facilitate use of additional batteries to increase operational duration of the video flashlight. Therefore, the above description should not be taken as limiting the scope of the invention which is defined by the appended claims.

What is claimed is:

1. A security system, comprising:
a) a flashlight for selectively emitting a beam of light, said flashlight including:
1) a video camera, having an optical axis generally along said beam of light, for converting an image received along said optical axis into an electronic image;
2) a transmitter, coupled to said video camera, for broadcasting said electronic image as a broadcast image; and
3) a power cell, coupled to said video camera and to said transmitter, for providing operating power such that said flashlight is portable; and
b) a remote unit, including:
1) a receiver for receiving said broadcast image and converting it back to said electronic image; and
2) at least one of the following:
i) a monitor, coupled to said receiver, for displaying said electronic image as said image; and
ii) a recorder, coupled to said receiver, for recording said electronic image in a format suitable for recovery of said image at a later time.

2. The security system of claim 1 wherein said remote unit comprises only said recorder.

3. The security system of claim 1 wherein said remote unit is installed in a passenger vehicle.

4. The security system of claim 3 wherein said remote unit comprises said recorder, and said recorder is installed in a locked compartment of said passenger vehicle.

5. The security system of claim 1 wherein said flashlight includes an on/off switch and is operable independently of said video camera.

6. The security system of claim 1 wherein said video camera includes an on/off switch and is operable independently of said flashlight.

7. The security system of claim 1 wherein said flashlight further includes a microphone, coupled to said transmitter, for converting sounds from a region near said flashlight into audio signals,
wherein said transmitter broadcasts said audio signals as audio data and wherein said receiver converts said audio data into said audio signals and wherein said monitor audiblizes said audio signals.

8. The security system of claim 7 wherein said remote unit includes said monitor.

9. The security system of claim 8 wherein said monitor audiblizes said audio signals concurrent with display of said electronic image.

10. The security system of claim 7 wherein said remote unit includes a repeater, coupled to said receiver, for rebroadcasting said broadcast image and said audio data to other receivers.

11. A security system, comprising:
a) a flashlight, having an optical axis, for selectively emitting a beam of light along said optical axis, said flashlight including:
1) a video camera for converting an image along said optical axis into an electronic image;
2) a transmitter, coupled to said video camera, for broadcasting said electronic image as a broadcast image; and
3) a power cell, coupled to said video camera and to said transmitter, for providing operating power such that said flashlight is portable; and
b) a remote unit, including:
1) a receiver for receiving said broadcast image and converting it back to said electronic image; and
2) a recorder, coupled to said receiver, for recording said electronic image in a format suitable for recovery of said image at a later time.

12. A method for providing security to an area, comprising the steps of:
broadcasting a series of real-time images with accompanying audio signals, from a flashlight for emitting a flashlight beam, said flashlight having an integrated video camera and microphone coupled to a transmitter, said video camera defining an optical axis generally along said flashlight beam wherein said series of real-time images are captured by said integrated video camera;
receiving said series of real-time images and audio signals at a remote receiver; and
capturing said series of real-time images by selecting at least one of the following steps:
displaying said series of real-time images on a monitor coupled to said receiver while concurrently audiblizing said audio signals; and
recording said series of real-time images in a format suitable for recovery of said real-time images at a later time.

13. A method for providing security to an area, comprising the steps of:
equipping a security officer, associated with a security team, with a flashlight constructed for emitting a beam of light;
broadcasting a series of real-time images with accompanying audio signals from said flashlight, wherein said flashlight includes an integrated wireless video camera and microphone coupled to a transmitter, and wherein said series of real-time images are captured by said integrated video camera from a field-of-view along an optical axis oriented generally along said beam of light;
receiving said series of real-time images and audio signals at a receiver operated at a remote location wherein a team member of said security officer is located; and
capturing said series of real-time images by selecting at least one of the following steps:
1) displaying to said team member said series of real-time images by use of a monitor coupled to said receiver, and audiblizing said audio signals to said team member while displaying said series of real-time images; and
2) recording, by use of a recorder coupled to said receiver, said series of real-time images in a format for later recovery and display by said team member.

14. The security providing method of claim 13 further comprising the steps of:
rebroadcasting said series of real-time images and audio signals by use of a repeater coupled to said receiver;
receiving said rebroadcast series of real-time images and audio signals by use of a second receiver operated at a second remote wherein a second team member of said security officer is located;
displaying to said second team member said series of real-time images by use of a second monitor coupled to said second receiver; and
audiblizing said audio signals to said second team member while displaying said series of real-time images.

15. The security providing method of claim 13 further comprising the steps of:
narrating, by said security officer, said series of real-time images to provide a narration as part of said audio signals; and
recording, by use of a recorder coupled to said receiver, said series of real-time images and said narration.
